(19) United States
(12) Patent Application Publication
(10) Pub. No.: US 2024/0032508 A1
(43) Pub. Date: Feb. 1, 2024

(54) PET HAIR COMBING DEVICE

(71) Applicant: YIWU DOUNATU TECHNOLOGY CO., LTD., JINHUA (CN)

(72) Inventor: Su OUYANG, Shenzhen (CN)

(73) Assignee: YIWU DOUNATU TECHNOLOGY CO., LTD., JINHUA (CN)

(21) Appl. No.: 18/305,452

(22) Filed: Apr. 24, 2023

(30) Foreign Application Priority Data
Jul. 28, 2022 (CN) 2022219775609

(51) Int. Cl. A01K 13/00; A45D 24/04

(52) U.S. Cl. CPC A01K 13/002; A45D 24/04

(57) ABSTRACT

The present invention patent provides a pet hair combing device comprising a handle body and a combing mechanism set on the handle body. The combing mechanism is detachably connected to the handle body and includes a first combing mechanism and a second combing mechanism. The first combing mechanism is used for combing pet hair and is detachably connected to the handle body. The second combing mechanism is provided with a hair removal mechanism for cleaning the hair on the second combing mechanism. By providing two combing mechanisms, which can be alternately replaced, and a hair removal mechanism on the second combing mechanism, the present invention patent provides a flexible and convenient design for combing pet hair.

### CROSS-REFERENCE TO RELATED APPLICATIONS

The application claims priority to Chinese patent application No. 2022219775609, filed on Jul. 8, 2022, the entire contents of which are incorporated herein by reference.

### TECHNICAL FIELD

The present invention patent relates to the technical field of pet care equipment, and specifically relates to a pet hair combing device.

### BACKGROUND TECHNOLOGY

In daily life, there are many types of pets, but most countries still limit pets to animals, such as cats and dogs, which are common pets in daily life. Pets are creatures that people raise for spiritual purposes. Pet cats and dogs are raised for appreciation and companionship, to relieve people's mental stress, and to meet human psychological needs. They are also creatures that can get along with humans friendly. With the increasing living standards, people's demand for the types of equipment that can be used or decorated in daily life for pets is also increasing. For example, a comb used to comb pet hair is a necessary pet care device for every pet lover. The structure of existing single pet combs is relatively simple. Some hair combs are suitable for combing coarse hair. If they encounter fine hair, two types of combs need to be configured. After combing the pet's hair, some small pet hair will stick to the comb because some pet hair is relatively fine, and it is inevitable that the hair will fall off during combing. Most of the hair will stick to the comb, and most of the comb teeth on the hair comb are densely set, so the hair comb will stick to the hair after a period of use. It is difficult to clean, so a pet hair combing device that can be cleaned in time and is easy to use is needed.

### SUMMARY

Based on this, it is necessary for the present invention patent to provide a pet hair combing device that can clean the comb when combing pet hair and can replace the comb head mechanism. The present invention patent provides a pet hair combing device, which includes a handle body and a comb head mechanism set on the handle body. The comb head mechanism is detachably connected to the handle body. The comb head mechanism includes a first comb head mechanism and a second comb head mechanism. The first comb head mechanism is used for combing pet hair and is detachably connected to the handle body. The second comb head mechanism is provided with a shedding mechanism for cleaning the hair on the second comb head mechanism. The second comb head mechanism is detachably connected to the handle body, and the first comb head mechanism and the second comb head mechanism are used alternately.

Therefore, it is necessary for this invention patent to provide a pet hair combing device that can clean the comb while combing the pet hair and can replace the comb head mechanism. This invention patent provides a pet hair combing device, including a handle body and a comb head mechanism set on the handle body. The comb head mechanism can be detachably connected to the handle body. The comb head mechanism includes a first comb head mechanism and a second comb head mechanism. The first comb head mechanism is used for combing pet hair and is detachably connected to the handle body. The second comb head mechanism is provided with a hair removal mechanism for cleaning the hair on the second comb head mechanism. The second comb head mechanism is detachably connected to the handle body, and the first comb head mechanism and the second comb head mechanism are used alternately and can be replaced.

Preferably, the first comb head mechanism includes a comb head connection seat, and the installation base is provided with a first installation surface and a second installation surface. The first combing member is installed on the first installation surface, and the second installation surface is provided with an elastic pushing member. The elastic pushing member includes a connecting piece, and the two ends of the connecting piece are connected to one end of the pushing piece. The second installation surface is provided with a connecting through hole, and the other end of the pushing piece penetrates through the connecting through hole and is connected to the first combing member.

Preferably, the first combing member includes a combing strip, which is installed on the first installation surface. The combing strip is provided with comb teeth, and the comb teeth are arranged in a row at intervals. The cleaning strip penetrates through the comb teeth, and the back of the cleaning strip is fixedly connected to the other end of the pushing piece.

Preferably, the elastic pushing member further includes an elastic member, and the middle of the connecting piece is provided with a connecting column in a cross shape. One end of the elastic member is connected to the connecting column. The middle of the second installation surface is provided with a connecting end, and the other end of the elastic member is sleeved in the connecting end. There are two connecting through holes on the connecting through hole, and the connecting through hole is connected to the through hole sleeve. The pushing piece has two ends, and the other end of each pushing piece penetrates through the through hole sleeve and is connected to the back of the cleaning strip.

Preferably, the two ends of the connecting piece are provided with card holding buckles, and the connecting slot is opened at one end of the pushing piece, and the connecting hole is opened on the connecting slot. The card holding buckle is connected to the connecting hole.

Preferably, the second combing mechanism includes a comb mounting seat, and a combing element is installed on the comb mounting seat. The combing element is installed on the comb mounting seat through an installation connecting component. The installation connecting component includes an upper mounting piece and a lower mounting piece. A connecting space is formed between the upper mounting piece and the lower mounting piece. One end of the combing element is fixedly connected to the upper mounting piece, and a part of the combing element is embedded in the connecting space, while another part of the combing element protrudes from the connecting space. The combing element has multiple comb teeth, which are spaced apart in a staggered shape.

Preferably, the hair removal mechanism includes a hair removal piece and a connecting elastic element. One end of the hair removal piece has a power contact end, and the middle position of the hair removal piece has a connection position, which is connected to one end of the connecting elastic element. The other end of the hair removal piece has a conical hair removal blade. The hair removal piece, the hair removal blade, and the power contact end are integrally formed.

Preferably, the lower mounting piece is provided with an installation connecting groove, which is used to install and connect the middle part of the hair removal piece. The installation connecting groove is provided with an elastic element connection end, which is used to connect the other end of the connecting elastic element. When the hair removal piece is installed on the installation connecting groove, in one state, a part of the hair removal blade is embedded in the connecting space, and in another state, the hair removal blade completely protrudes from the connecting space.

Preferably, the handle body is provided with a combing mechanism connection position, which is equipped with a combing mechanism connection groove. A connection hole is provided on the combing mechanism connection groove. The upper end of the combing mechanism connection groove is provided with a first connection hole, the middle part of the combing mechanism connection groove is provided with a second connection hole, and the lower end of the combing mechanism connection groove is provided with a third connection hole. The second connection hole is a polygonal connection hole. The first combing mechanism and the handle body are connected and held by the connection hole. The second combing mechanism is connected and held by the connection hole.

Preferably, the handle body includes a handle installation seat and an installation seat cover. The main force driving member is installed in the handle installation seat, and the middle position of the main force driving member is provided with a connection convex point. The main force driving member can be rotated and installed on the handle installation seat through the connection convex point. One end of the main force driving member is a thrusting end, which acts on the connection piece of the first combing mechanism when using the first combing mechanism, and acts on the power contact end of one end of the hair removal piece when using the second combing mechanism. The other end of the main force driving member is provided with a circular pressing end. The main force driving member is a lever-shaped main force driving member with an angle in the middle.

The invention patent has the beneficial effect of providing a pet hair combing device with flexible structure design, which sets up the first combing mechanism and the second combing mechanism. The first and second combing mechanisms can be alternately replaced and used. The hair removal mechanism is placed on the second combing mechanism, which can timely clean the hair on the combing mechanism. The structure design of the invention patent is flexible, and two combing mechanisms are provided, which is convenient to use.

### BRIEF DESCRIPTION OF DRAWINGS

The preferred embodiments of the present invention patent are described in more detail with reference to the accompanying drawings, so that the above and other objectives, features, and advantages of the present invention patent will become clearer. In all of the drawings, the same reference numerals indicate the same parts, and the drawings are not intentionally drawn to scale, with emphasis on illustrating the essence of the present invention patent.

FIG. 1 is a plan view of the pet hair combing device of the present invention patent;

FIG. 2 is a plan view of the second combing mechanism of the pet hair combing device of the present invention patent;

FIG. 3 is an exploded view of the structure of the pet hair combing device of the present invention patent;

FIG. 4 is a plan view of the structure of the pet hair combing device of the present invention patent after being disassembled;

FIG. 5 is a schematic diagram of the second combing mechanism of the pet hair combing device of the present invention patent after disassembly;

FIG. 6 is a schematic diagram of the structure disassembly of the second combing mechanism of the pet hair combing device of the present invention patent.

In the drawings:

handle body 1; connecting groove 2; first connecting hole position 3; second connecting hole position 4; third connecting hole position 5; handle mounting seat 6; mounting seat cover body 7; main driving member 8; thrusting end 9; connecting convex point 10; pressing end 11; first combing mechanism 12; second combing mechanism 13; combing head connecting seat 14; first combing part 15; combing blade 16; connecting piece 17; connecting column 18; holding clip 19; pushing piece 20; connecting hole 21; connecting through-hole 22; through-hole sleeve 23; cleaning piece 24; strip-shaped through-hole 25; elastic member 26; connecting end 27; combing head mounting seat 28; combing part 29; upper mounting piece 30; mounting connecting groove 31; lower mounting piece 32; hair removal part 33; power contact end 34; hair removal blade 35; connecting elastic member 36.

### DETAILED DESCRIPTION OF EMBODIMENTS

The following embodiments, in conjunction with the accompanying drawings and specific examples, further describe the technical solution of the present invention patent in detail so that those skilled in the art can better understand and implement the present invention patent. However, the examples provided do not limit the present invention patent.

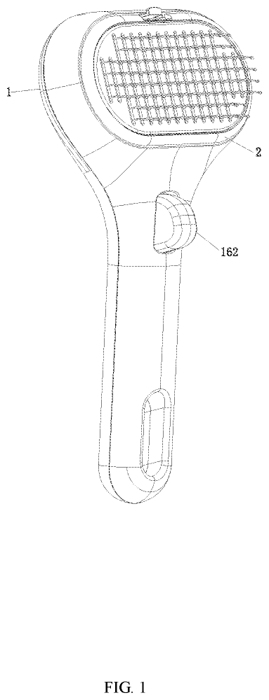

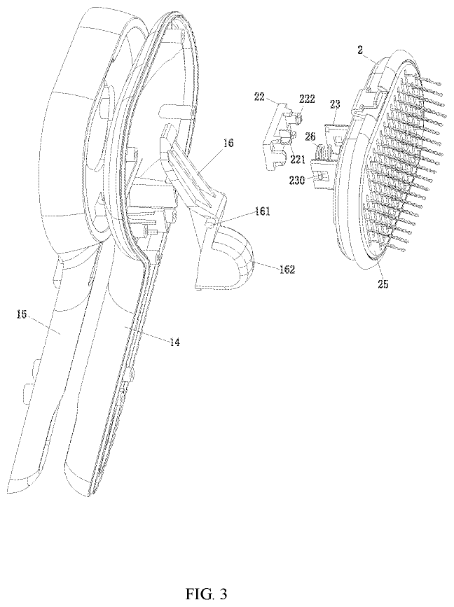

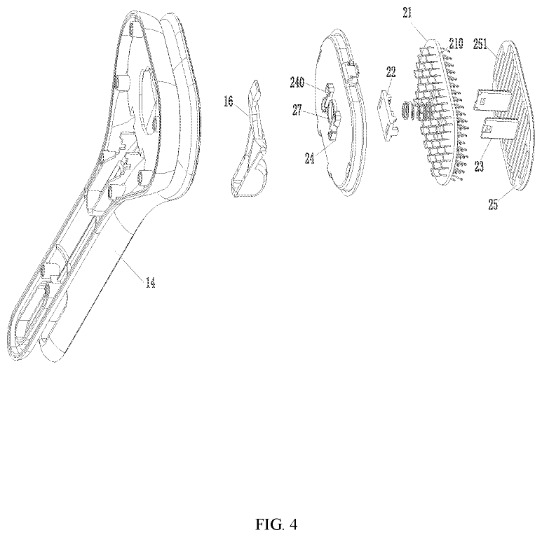

As shown in FIGS. 1-6, an embodiment of the present invention patent provides a pet hair combing device, comprising a handle body 1 and a combing mechanism set on the handle body, the combing mechanism being detachably connected to the handle body 1. The combing mechanism includes a first combing mechanism 2 and a second combing mechanism 3. The first combing mechanism 2 is used for combing pet hair and is detachably connected to the handle body. The second combing mechanism 3 is provided with a hair removal mechanism for cleaning hair from the second combing mechanism 3. The second combing mechanism 3 is detachably connected to the handle body 1. The first combing mechanism 2 and the second combing mechanism 3 are used alternately. The first and second combing mechanisms are two different styles of hair combs. The first combing mechanism 2 is a commonly used hair comb, while the second combing mechanism 3 has a row of teeth, and the hair removal mechanism on the second combing mechanism 3 can remove hair that is stuck to the second combing mechanism, allowing it to fall off and be cleaned from the comb in a timely manner.

Referring to FIGS. 1-4, in further preferred embodiments, the first combing mechanism 2 includes a combing head connecting base 20. The mounting base has a first mounting surface and a second mounting surface. The first combing piece 21 is mounted on the first mounting surface, and the second mounting surface is provided with an elastic pushing member. The elastic pushing member includes a connecting piece 22, the two ends of which are connected to one end of a pushing piece 23. Specifically, the pushing piece 23 has two ends, each of which is connected to one end of the connecting piece. A connecting through-hole 24 is provided on the second mounting surface. The other end of the pushing piece passes through the connecting through-hole 24 and is connected to the first combing piece 21. When the pushing piece 23 moves forward, it must first pass through the connecting through-hole 24.

In the further preferred embodiment with reference to FIGS. 1-4, the first combing piece 21 includes combing blades 210 that are mounted on the first mounting surface. The combing blades 210 are provided with comb teeth that are spaced apart in a comb-like arrangement. A cleaning piece 25 is connected to and passes through the combing blades 210. The cleaning piece 25 is provided with a series of elongated through holes 251 that are spaced apart to correspond with the comb teeth, which are arranged in rows with spaces between them. Thus, the elongated through holes 251 on the cleaning piece 25 can be used to pass through the comb teeth in rows. The cleaning piece 25 is fixedly connected to the other end of a driving piece, which is also fixedly connected to the back of the cleaning piece 25. When the driving piece moves forward, it drives the cleaning piece to move back and forth to remove hair from the comb teeth.

In the further preferred embodiment with reference to FIGS. 1-4, the elastic driving assembly further includes an elastic piece 26, which in this embodiment is a spring. The central portion of the connecting piece 22 is provided with a cross-shaped connecting column 221. One end of the elastic piece is connected to the connecting column 221, while the other end is fitted inside a circular connecting end 27 that is located at the center of the second mounting surface. The connection structure of the elastic piece is firmly fixed. Two connecting through holes 24 are provided on the connecting end 27, each of which is connected to a through hole sleeve 240 for the stability of the elastic driving piece's reciprocating motion through the connecting through hole under the action of the elastic piece. Two driving pieces 23 are provided, each of which is connected to the other end of the elastic driving piece through the through hole sleeve and then connected to the back of the cleaning piece. The provision of two driving pieces enhances the structural stability of the first comb head assembly.

In the preferred embodiment with reference to FIGS. 1-4, the two ends of the connecting piece 22 are provided with card holding clasps 222, while the other end of the driving piece 23 is provided with a connecting slot with a connecting hole 230. The card holding clasps 222 are matched with the connecting hole 230 to facilitate disassembly and maintenance, and facilitate replacement of the connecting components.

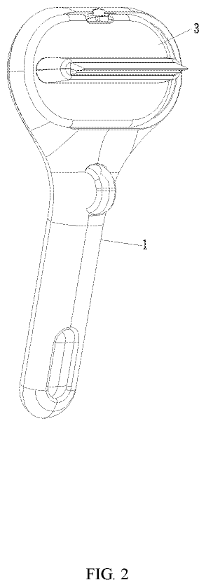

In the preferred embodiment, as shown in FIGS. 2-6, the second comb mechanism 3 includes a comb mounting base 31, on which a combing element 32 is provided. The combing element 32 is installed on the comb mounting base 31 via installation connecting pieces, which comprise an upper mounting piece 33 and a lower mounting piece 34. A connection space is formed between the upper mounting piece 33 and the lower mounting piece 34. One end of the combing element is fixedly connected to the upper mounting piece, with a portion of the combing element embedded within the connection space and another portion protruding outside of the connection space. The combing element 32 has multiple teeth arranged in a staggered fashion in a shape resembling the letter “I”. The I-shaped comb teeth are suitable for combing fine hair or for finely combing hair. The combing element is fixed to the mounting base, and the connection structure is stable.

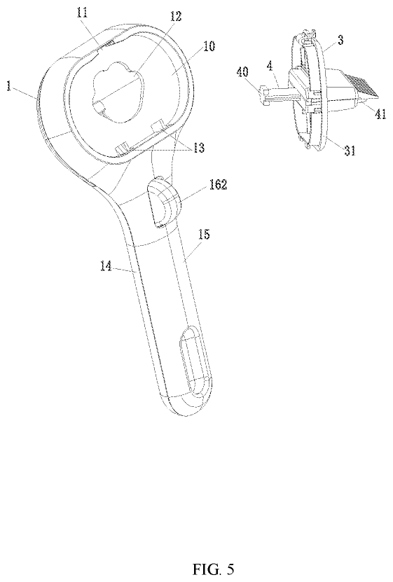

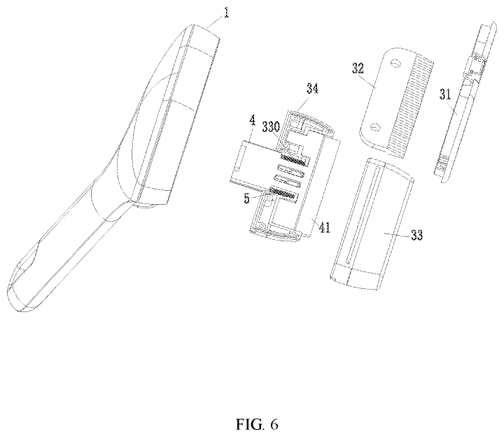

In the preferred embodiment, as shown in FIGS. 5-6, the hair removal mechanism includes a hair removal element 4 and a connecting elastic piece 5. One end of the hair removal element 4 has a power contact end 40, and the middle position of the hair removal element 4 is provided with a connection site that connects to one end of the elastic piece. The other end of the hair removal element is provided with a conical hair removal piece 41. The hair removal element, hair removal piece, and power contact end are integrally formed. The hair removal element is retractable and connected to the lower mounting piece, and can expand and retract within the connection space. The hair removal piece 41 can extend outside the lower mounting piece.

In a further preferred embodiment, as shown in FIGS. 5-6, the lower mounting piece 33 is provided with an installation connecting groove 330 for installing and connecting the middle part of the hair removal element. The installation connecting groove 330 is provided with an elastic piece connection end. Specifically, in this embodiment, two elastic connecting pieces are provided, each of which is connected to the elastic piece connection end with intervals. The elastic piece connection end is used to connect the other end of the elastic connecting piece. When the hair removal element is installed on the installation connecting groove, in one state, a part of the hair removal piece is embedded within the connection space, while in another state, the hair removal piece completely protrudes outside the connection space. By applying an external force to the power contact end of the hair removal element, the hair removal element can be switched between these two states. When the hair removal piece protrudes outside the connection space, it can be used to remove hair from the combing element, thus cleaning the combing element.

In a further preferred embodiment, as shown in FIGS. 5-6, the handle body 1 is provided with a connecting site for the comb mechanism. The comb mechanism connecting site is provided with a comb connection groove 10, which is provided with a connection hole. The upper end of the comb connection groove is provided with a first connection hole 11, the middle part of the comb connection groove is provided with a second connection hole 12 in a polygonal shape, and the lower end of the comb connection groove is provided with a third connection hole 13. The first comb mechanism and the handle body are connected and held together by the first connection hole, while the second comb mechanism is connected and held together by the second connection hole. The setting of three comb connection holes ensures that the comb connection structure is stable, and also facilitates the disassembly and replacement of the two combs.

In the further preferred embodiment with reference to FIGS. 5-6, the handle body 1 includes a handle mounting seat 14 and a mounting seat cover 15. A main driving member 16 is installed inside the handle mounting seat 14, and a connection protrusion 161 is located at the middle position of the main driving member 16. The main driving member 16 can be rotated and installed on the handle mounting seat 14 via the connection protrusion 161. One end of the main driving member 16 is a thrust acting end 160, which acts on the connecting piece of the first combing mechanism when using the first combing mechanism, and acts on the power contact end of one end of the depilation piece when using the second combing mechanism. The other end of the main driving member 16 is provided with a circular pressing end 162, which is a circular pressing button. By pressing the button, the pressing force of the hand can be applied to the thrust acting end to drive the connecting piece or depilation piece to stretch and move. The main driving member 16 is a lever type main driving member with a middle angle.

The invention patent has the beneficial effect of providing a pet hair combing device, which sets up the first and second combing mechanisms that can be alternately replaced and used. The depilation mechanism is placed on the second combing mechanism, which can timely clean the hair on the combing mechanism. The structural design of the invention patent is flexible, with two combing structures, and easy to use.

The above is only a preferred embodiment of the invention patent, and the patent scope of the invention patent is not limited thereby. Equivalent structures or equivalent process transformations made based on the contents of the invention patent description and drawings, or directly or indirectly applied in other related technical fields, are also included in the patent protection scope of the invention patent.

A pet hair combing device comprising a handle body and a combing mechanism mounted on the handle body, wherein the combing mechanism is detachably connected to the handle body and includes a first combing mechanism and a second combing mechanism. The first combing mechanism is used for combing pet hair and is detachably connected to the handle body. The second combing mechanism is provided with a hair removal mechanism for cleaning the hair on the second combing mechanism. The second combing mechanism is detachably connected to the handle body, and the first combing mechanism and the second combing mechanism are used interchangeably.

What is claimed is:

1. A pet hair combing device comprising a handle body and a combing mechanism mounted on the handle body, wherein the combing mechanism is detachably connected to the handle body and includes a first combing mechanism and a second combing mechanism. The first combing mechanism is used for combing pet hair and is detachably connected to the handle body. The second combing mechanism is provided with a hair removal mechanism for cleaning the hair on the second combing mechanism. The second combing mechanism is detachably connected to the handle body, and the first combing mechanism and the second combing mechanism are used interchangeably.

2. The pet hair combing device according to claim 1, wherein the first combing mechanism includes a combing connector, and the installation base has a first installation surface and a second installation surface; the first combing piece is installed on the first installation surface, and an elastic pushing piece is installed on the second installation surface; the elastic pushing piece includes a connecting piece, and one end of a pushing piece is connected to each end of the connecting piece; the second installation surface has a connecting through hole, and the other end of the pushing piece passes through the connecting through hole and is connected to the first combing piece.

3. The pet hair combing device according to claim 2, wherein the first combing piece includes a row of combing pieces which are mounted on the first installation surface; the combing pieces are provided with comb teeth arranged in a row; a cleaning piece penetrates through the comb teeth, and a series of elongated through holes are arranged on the cleaning piece; the through holes pass through the comb teeth, and the back of the cleaning piece is fixedly connected to the other end of the pushing piece.

4. The pet hair combing device according to claim 3, characterized in that the elastic pushing member further includes an elastic member, the middle position of the connecting piece is provided with a connecting column which is cross-shaped, one end of the elastic member is connected to the connecting column, the middle position of the second mounting surface is provided with a connecting end, and the other end of the elastic member is sleeved inside the connecting end; the connecting through hole has two holes which are spaced apart on both sides of the connecting end, and the connecting through hole is connected with a through hole sleeve; the pushing piece is provided with two, and the other end of each pushing piece passes through the through hole sleeve and connects to the back of the cleaning piece.

5. The pet hair combing device according to claim 2, characterized in that the connecting piece is provided with card holding buckles at both ends, one end of the pushing piece is provided with a connecting groove, and a connecting hole is provided on the connecting groove, the card holding buckles are connected with the connecting hole.

6. The pet hair combing device according to claim 1, characterized in that the second combing head mechanism includes a combing head mounting base, a combing piece is provided on the combing head mounting base, the combing piece is installed on the combing head mounting base through an installation connecting piece, the installation connecting piece includes an upper installation piece and a lower installation piece, a connecting space is formed between the upper installation piece and the lower installation piece, one end of the combing piece is fixedly connected to the upper installation piece, a part of the combing piece is embedded in the connecting space, another part of the combing piece protrudes outside the connecting space, the combing piece is provided with multiple comb teeth, and the multiple comb teeth are arranged in a staggered manner in a linear shape.

7. The pet hair combing device according to claim 1, wherein the hair removal mechanism comprises a hair removal piece and a connecting elastic member; one end of the hair removal piece is provided with a power contact end, the middle position of the hair removal piece is provided with a connecting position, and one end of the connecting elastic member is connected to the connecting position; the other end of the hair removal piece is provided with a conical hair removal piece, and the hair removal piece is integrally formed with the hair removal piece and the power contact end.

8. The pet hair combing device according to claim 6, wherein the lower mounting plate is provided with an installation connecting groove, and the installation connecting groove is used for installing and connecting the middle body of the hair removal piece; the connecting groove is provided with an elastic member connecting end, and the elastic member connecting end is used for connecting the other end of the connecting elastic member; when the hair removal piece is installed on the connecting groove, in one state, a part of the hair removal piece is embedded in the connecting space, and in another state, the hair removal piece completely protrudes from the connecting space.

9. The pet hair combing device according to claim 1, wherein the handle body is provided with a combing mechanism connecting position, the combing mechanism connecting position is provided with a combing mechanism connecting groove, and the combing mechanism connecting groove is provided with a connecting hole position; the upper end of the combing mechanism connecting groove is provided with a first connecting hole position, the middle part of the combing mechanism connecting groove is provided with a second connecting hole position, and the lower end of the combing mechanism connecting groove is provided with a third connecting hole position the second connecting hole position is a polygonal connecting hole position; the first combing mechanism is connected and held to the handle body through the connecting hole position, and the second combing mechanism is connected and held to the handle body through the connecting hole position.

10. The pet hair combing device according to claim 1, characterized in that the handle body comprises a handle mounting seat and a mounting seat cover; the main force driving member is installed inside the handle mounting seat, and the middle position of the main force driving member is provided with a connecting convex point; the main force driving member can be rotated and installed on the handle mounting seat through the connecting convex point; one end of the main force driving member is a pushing action end; when using the first combing mechanism shown, the pushing action end acts on the connecting piece of the first combing mechanism; when using the second combing mechanism shown, the pushing action end acts on the power contact end of one end of the hair removal piece; the other end of the main force driving member is provided with a circular pressing end, and the main force driving member is a lever-type main force driving member with a middle angle.
